(19) United States
(12) Patent Application Publication
(10) Pub. No.: US 2005/0195473 A1
(43) Pub. Date: Sep. 8, 2005

(54) Selective amplification and/or filtering of frequency bands via nonlinear optical frequency conversion in aperiodic engineered materials

(76) Inventors: Phillip T. Nee, Simi Valley, CA (US); Jeffrey H. Hunt, Thousand Oaks, CA (US)

Correspondence Address: GREG J MICHELSON;MACPHERSON KWOK CHEN & HEID LLP, 1762 TECHNOLOGY DRIVE, SUITE 226, SAN JOSE, CA, 95110, US

(21) Appl. No.: 10/794,618

(22) Filed: Mar. 5, 2004

(51) Int. Cl. H01S 3/00

(52) U.S. Cl. 359/333

(57) ABSTRACT

The present application is directed to methods and devices for selectively amplifying and/or filtering frequency bands. In one embodiment, a method for selectively amplifying and/or filtering frequency bands is disclosed and includes providing a light source of an first wavelength, selecting an output comprising at least a second wavelength, the second wavelength differing from the first wavelength, calculating a domain architecture for a nonlinear optical material configured to output the second wavelength from an input of the first wavelength, aperdiocially poling the nonlinear optical material to create an aperiodic nonlinear optical material having the calculated domain architecture, irradiating the aperiodic nonlinear optical material with the first wavelength from the light source, and outputing the second wavelength from the aperiodic nonlinear optical material.

### BACKGROUND

The widespread use of optical systems in communications, data storage, and other applications has resulted in the search for optical materials capable of amplifying and/or filtering a number of frequency bands around a particular user-defined wavelength. In recent years, research into the characteristics and capabilities of nonlinear optical materials has increased. A number of nonlinear optical materials having desirable optical properties have been identified. For example, some nonlinear optical materials, including inorganic materials such as KH₂PO₄, LiNbO₃, and KiTaO₃, have been used to convert an incoming optical wavelength to a predetermined output optical wavelength.

While the use of nonlinear optical materials for the amplification and/or filtering of some frequency bands has proven successful in some applications, a number of shortcomings have been identified. For example, during amplification and/or filtering processes, the frequency conversion efficiency may be unacceptably low for some applications. For example, an input of 100W at a first wavelength irradiating a nonlinear optical material may yield an output of about 0.30W at a second wavelength. As such, an unacceptably large input power at a first wavelength may be required to produce a usable output power at a second wavelength.

Thus, in light of the foregoing, there is an ongoing need for the selective amplification and/or filtering of frequency bands of at user-defined wavelength.

### BRIEF SUMMARY

The methods and devices disclosed herein enable a user to selectively amplify and/or filter frequency bands using aperiodic nonlinear optical materials. In addition, the various methods and devices disclosed herein permit a user to more efficiently output light at a selected wavelength than methods and devices currently available.

In one embodiment, the present application is directed to a device for the selective amplification and/or filtering of frequency bands and includes an aperiodically poled nonlinear optical material substrate. The periodicity of the poling is configured to amplify and/or filter light at a user-selected second wavelength with the desired spectral profile when irradiated with a first wavelength of light.

In an alternate embodiment, the present application is directed to a method for making a device for the selective amplification and/or filtering of frequency bands and includes providing a nonlinear optical material, selecting at least one output wavelength of light, calculating an aperiodic polarization domain architecture for the nonlinear optical material configured to provide an output wavelength having the desired spectral profile based on a wavelength of a source, and aperiodically poling the nonlinear optical material to include the calculated domain architecture.

In addition, the present application is directed to a method for selectively amplifying and/or filtering frequency bands and includes providing a light source of a first wavelength, selecting an output comprising at least a second wavelength, the second wavelength differing from the first wavelength, calculating a domain architecture for a nonlinear optical material configured to output the second wavelength with the desired spectral profile from an input of the first wavelength, aperdiocially poling the nonlinear optical material to create an aperiodic nonlinear optical material having the calculated domain architecture, irradiating the aperiodic nonlinear optical material with the first wavelength from the light source, and outputing the second wavelength from the aperiodic nonlinear optical material.

Other features and advantages of the embodiments of the methods and devices disclosed herein will become apparent from a consideration of the following detailed description.

### BRIEF DESCRIPTION OF THE DRAWINGS

Various methods and devices for selectively amplifying and/or filtering frequency bands will be explained in more detail by way of the accompanying drawings, wherein:

FIG. 1 shows a schematic diagram of an embodiment of an optical amplification and/or filtering device;

FIG. 2 shows a schematic diagram of a portion of the embodiment of the optical amplification and/or filtering device shown in FIG. 1;

FIG. 3 graphically shows the conversion efficiency of a periodically poled nonlinear material when irradiated with an input wavelength; and

FIG. 4 graphically shows the conversion efficiency of a aperiodically poled nonlinear material when irradiated with an input wavelength.

### DETAILED DESCRIPTION

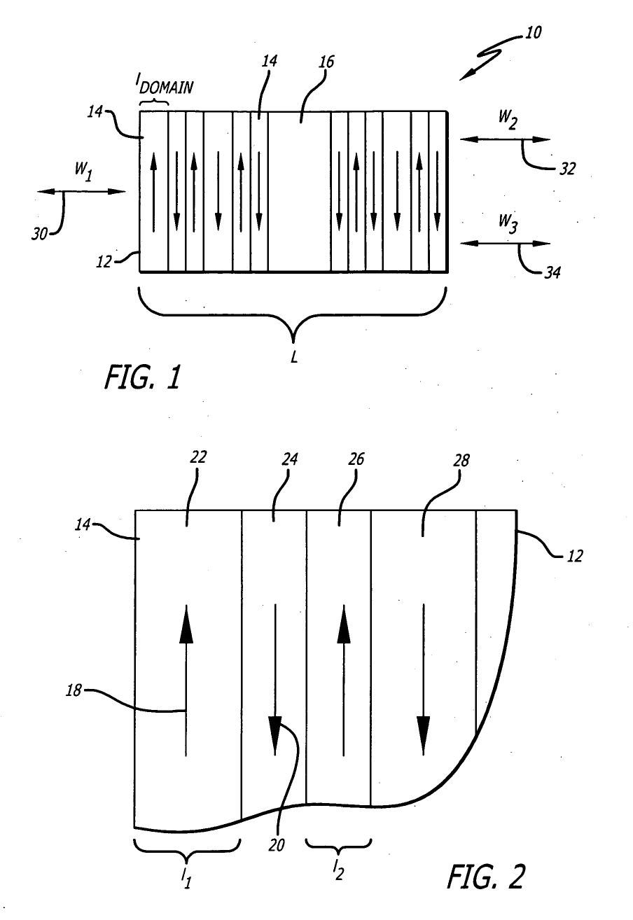

FIG. 1 shows an embodiment of an optical amplification and/or filtering device. As shown, the amplification and/or filtering device 10 comprises a substrate 12 having a length L formed by multiple layers 14 of a nonlinear optical material. The substrate 12 may be formed of any number of layers 14 as desired. In one embodiment, the layer 14 comprise segmented portion of a nonlinear material. In an alternate embodiment, the layers 14 comprise areas of inverse polarization within a nonlinear material substrate. As such, the substrate 12 may be manufactured in any variety of lengths. In the illustrated embodiment, the substrate includes a portion 16 having layers 14 affixed thereto. Optionally, the substrate 12 may be manufactured entirely from multiple layers 14 of nonlinear optical material, thereby eliminating portion 16. In another embodiment, portion 16 comprises either a nonlinear or linear optical material.

The substrate 12 may be formed from multiple layers 14 of the same nonlinear optical material. In an alternate embodiment, the substrate 12 may be formed from multiple layers 14 of a variety of nonlinear optical materials. As such, the signal or wavelength amplification and/or filtering device 10 may be engineered to provide the optical characteristics desired by a user. For example, the signal or wavelength amplification and/or filtering device 10 may be comprised of two nonlinear optical materials having identical optical characteristics. In an alternate embodiment, the amplification and/or filtering device 10 may be manufactured from different nonlinear materials having different optical characteristics, such as index of refraction or birefringent characteristics. Exemplary nonlinear optical materials include, without limitation, Lithium niobate (LiNbO₃), Litium borate (LiB₃O₅), beta-Barium-borate(β-BaB₂O₄), Potassium dihydrogen phosphate (KH₂PO₄), Deuterated potassium dihydrogen phosphate (KD₂PO₄), Cesium lithium borate (CsLiB₆O₁₀), Potassium titanyl phosphate (KTiOPO₄), crystals formed of N-(4-nitrophenyl)-L-prolinol, polymers having nonlinear optical materials, and other nonlinear optical materials.

As shown in FIGS. 1 and 2, the domains of the layers 14 of the substrate 12 may be alternately inverted, thereby forming an inverted domain structure with inverted nonlinear optical coefficients in adjoining layers. As such, the domain of a number of the layers 14 is oriented in a first direction or poling 18. Similarly, the domain of a number of other layers 14 is oriented in a second direction or poling 20. For example, FIG. 2 shows a portion of the substrate 12 wherein the domain of layers 22 and 26 is poled in a first direction 18 and the domain of layers 24 and 28 is poled in a second direction. In one embodiment, the domains of the layers 14 or the substrate 12 may be selective poled by coupling electrodes to opposing surfaces of the substrate 12 and applying an electric field thereto. The application of an electric field to the substrate 12 results in a change in the ions in the crystal lattice of the nonlinear optical material thereby orienting the field as desired. In one embodiment, at least one of the electrodes may be applied using photolithographic processes.

Referring again to FIGS. 1 and 2, in one embodiment the length of the individual layers 14 forming the substrate 12 varies, wherein the length (l_{domain}) of a layer 14 less than the length L of the substrate 12. As such, the substrate 12 forms an aperiodically poled nonlinear optical material. For example, FIG. 2 shows an embodiment of the substrate 12 wherein layer 22 has a first length l₁ and layer 26 has a second length l₂, such that l₁ is greater than l₂. Similarly, the layers 24 and 28 may having different lengths also. In one embodiment, the length of the layers 14 range from about 1.5 microns to about 20 microns. Optionally, the linear coefficient d_{Q} of the substrate 12 may be altered by varying the thickness of the domains aperiodically dispersed within the substrate 12. As such, the wavelength of light emitted from the substrate 12 will be varied accordingly. The domain coefficient d_{Q} may be calculated by the following equation:
d_{Q}(z)=CF⁻¹{η(Δk)}
wherein z represents the propagation distance, C represents a mutliplicative term which is a function of the material and the relative orientation of the crystal axes with respect to the polarizations of the input and output radiation, F⁻¹ represents an inverse Fourier transform, η represents a normalized conversion efficiency, and Δk represents a wave vector mismatch which is primarily a function of temperature, wavelength(s) of the interacting fields, and the indices of refraction of the nonlinear material.

FIG. 1 shows an embodiment of the amplification and/or filtering device 10 during use. Initially, a user would determine the wavelength of a source and a desired output wavelength(s). Thereafter, the user calculates the length, number, and architecture of the domains to be created within the substrate 12 of the nonlinear optical material. Once the domain architecture has been calculated, the user may then manufacture the substrate in accordance with the calculated dimensions. Once manufactured, the user may irradiate the aperiodic nonlinear substrate 12 with the source wavelength and amplify and/or filter light at the desired output wavelength(s).

A number of methods may be used to manufacture the aperiodic nonlinear optical material. For example, in one embodiment a nonlinear optical material is uniformly poled to produce a uniformly poled nonlinear substrate (UPNS). Thereafter, the UPNS substrate is segmented to form individual layers having the length and thickness equal to the calculated dimensions. The substrate 12 is reformed by coupling the various layers 14 to form the aperiodic nonlinear substrate 12. In one embodiment, the layers 14 are coupled using an optically transparent adhesive or other coupling methods known in the art. Optionally, any number or type of patterns may be added to, imprinted on, or otherwise disposed on any one or multiple layers 14 of the substrate 12. For example, one or more layers 14 may include various gratings, random shapes or forms, or other designs disposed thereon. Optionally, the forms or patterns may be applied to the layers 14 in any number of ways, including, without limitation, through lithography and vapor deposition. As such, the forms or patterns formed on the layers 14 may comprise poling regions, thereby further aperiodically poling the substrate 12.

In an alternate embodiment, electrodes are coupled to a nonlinear optical substrate in a aperiodic pattern. Thereafter, an electric field in applied to the substrate 12 thereby aperiodcally forming domain layers 14 within the substrate 12. As such, the user may calculate the domain architecture of the aperiodic nonlinear material to output the desired wavelength(s) of light with the desired spectral profile based on the wavelength of the incident light and engineer the nonlinear substrate accordingly.

During use, the aperiodically poled substrate 12 is positioned within an optical system and illuminated with the first wavelength 30. As such, the first wavelength 30 may be considered the source wavelength having an angular frequency of ω₁. In response, at least light of a second wavelength 32 having an angular frequency of ω₂ and light of a third wavelength 34 having an angular frequency of ω₃ are emitted from the substrate 12. The relationship between the angular frequencies may be expressed as follows:
ω₁=ω₂+ω₃
Further, the relationship between the wave vectors for each wavelength may be expressed as follows:
Δ\overline{k}=\overline{k₁}−(\overline{k}₂+\overline{k}₃)
In addition, the incidence of the second and third wavelength light 32, 34, respectively, on the substrate 12 results in the substrate 12 emitting the first wavelength of light 30.

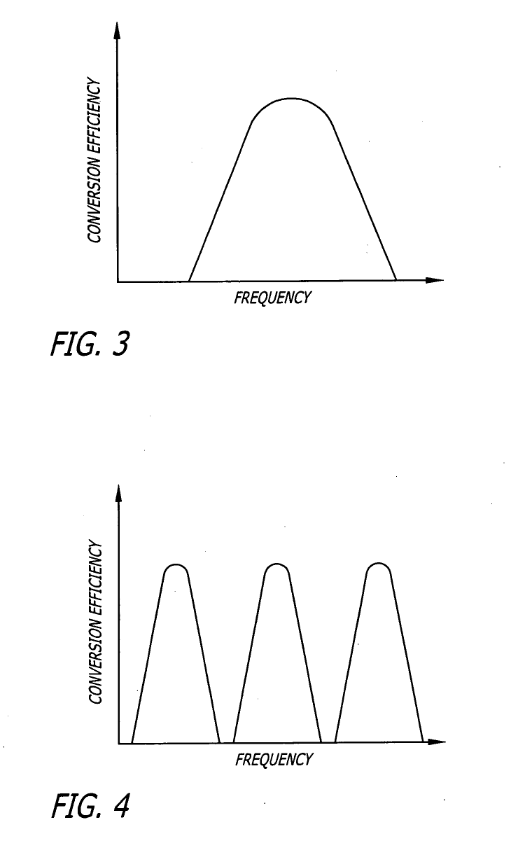

FIGS. 3 and 4 show graphically the transmission or amplification spectrum of a nonlinear optical interaction associated with a periodically poled nonlinear material when irradiated with an input wavelength as compared with that associated with an aperidocally poled nonlinear material irradiated with the same wavelength. The spectral profile of the periodically poled nonlinear optical material is well defined, with the conversion gain assuming a sinc profile as a function of the wave vector mismatch Δk. For example, FIG. 3 shows the conversion efficiency associated with a periodically poled nonlinear optical material as a function of frequency. In contrast, the conversion efficiency of the aperiodically poled nonlinear optical material may be tailored to generate user-selected outputs. For example, in one embodiment the outputs of an aperiodic nonlinear optical material may be tailored to produce outputs having complex spectral profiles at selected frequency bands. FIG. 4 shows the conversion efficiency of an exemplary aperiodic nonlinear optical material as a function of frequency.

Embodiments disclosed herein are illustrative of the principles of the invention. Other modifications may be employed which are within the scope of the invention, thus, by way of example but not of limitation, alternative nonlinear materials, alternative poling techniques, and alternative poling algorithms. Accordingly, the devices disclosed in the present application are not limited to that precisely as shown and described herein.

1. A device comprising an aperiodically poled nonlinear optical material substrate, the periodicity of the poling configured to output light at a user-selected second wavelength when irradiated with a first wavelength of light.

2. The device of claim 1 wherein the nonlinear optical material is selected from the group consisting of Lithium niobate, Litium borate, beta-Barium-borate, Potassium dihydrogen phosphate, Deuterated potassium dihydrogen phosphate, Cesium lithium borate, Potassium titanyl phosphate, crystals formed of N-(4-nitrophenyl)-L-prolinol, and nonlinear optical polymers.

3. The device of claim 1 further comprising a plurality of layers forming the substrate, each layer having a polarization orientation inverse to adjoining layers.

4. The device of claim 3 wherein the length of the layers ranges from about 1.5 microns to about 20 microns.

5. The device of claim 3 wherein the length of adjoining layers varies.

6. The device of claim 3 wherein the substrate is manufactured from one nonlinear optical material.

7. The device of claim 3 wherein the substrate is manufactured from two or more nonlinear optical materials.

8. A method comprising:
providing a nonlinear optical material;
selecting at least one output wavelength of light with user-defined spectral profile;
calculating an aperiodic polarization domain architecture for the nonlinear optical material configured to provide an output wavelength with a desired user-selected spectral profile based on a wavelength of a source; and
aperiodically poling the nonlinear optical material to include the calculated domain architecture.

9. The method of claim 8 further comprising forming layers of inverse polarization within the nonlinear optical material.

10. The method of claim 8 further comprising:
providing a uniformly poled nonlinear optical material;
segmenting the uniformly poled nonlinear optical material into a plurality of layers;
reconfiguring the plurality of layer to alter the periodicity of the nonlinear optical material to form an aperiodic nonlinear optical material.

11. The method of claim 8 further comprising applying an electric field to the nonlinear optical material to configure polarization.

12. The method of claim 8 further comprising defining a desired spectral profile for the output wavelength and outputting light having a user-defined spectral profile.

13. A method comprising:
providing a light source of a first wavelength;
selecting an output comprising at least a second wavelength having a user defined spectral profile, the second wavelength differing from the first wavelength;
calculating a domain architecture for a nonlinear optical material configured to output the second wavelength from an input of the first wavelength;
aperdiocially poling the nonlinear optical material to create an aperiodic nonlinear optical material having the calculated domain architecture;
irradiating the aperiodic nonlinear optical material with the first wavelength from the light source; and
outputing the second wavelength having the desired spectral profile from the aperiodic nonlinear optical material.
